(19) United States
(12) Patent Application Publication
(10) Pub. No.: US 2012/0183170 A1
(43) Pub. Date: Jul. 19, 2012

(54) SPEAKER UNIT AND ELECTRONIC DEVICE HAVING THE SAME

(76) Inventor: Hung-Chih Chen, New Taipei City (TW)

(21) Appl. No.: 13/434,568

(22) Filed: Mar. 29, 2012

(30) Foreign Application Priority Data
Jan. 4, 2011 (TW) 100111575

(51) Int. Cl. H04R 1/02

(52) U.S. Cl. 381/386

(57) ABSTRACT

An electronic device includes a housing and a speaker unit. The housing includes an upper housing half and a lower housing half connected to and disposed under the upper housing half. The lower housing half is provided with at least one insert post. The speaker unit includes a magnetic element disposed on the upper housing half of the housing, and a speaker module including a speaker body disposed above and abutting against the lower housing half of the housing and having at least one post-connecting portion, and a magnetic body adapted for generating an audio signal. The post-connecting portion has a hole permitting the insert post to extend movably therethrough. A magnetic attractive force or a magnetic repulsive force exists between the magnetic element and the magnetic body.

### CROSS-REFERENCE TO RELATED APPLICATION

This application claims priority of Taiwanese Application No. 100111575, filed on Apr. 1, 2011, the disclosure of which is incorporated herein by reference.

### BACKGROUND OF THE INVENTION

1. Field of the Invention

This invention relates to an electronic device, and more particularly to an electronic device having a speaker unit.

2. Description of the Related Art

To promote functionality of a notebook computer to meet needs of consumers, various electronic modules (such as a speaker and a video camera) are built in the notebook computer. As such, it is necessary to avoid interferences between the electronic modules while operating.

In the case where a speaker is built in a notebook computer, the speaker acts as one of primary vibrating sources in the notebook computer. Referring to FIG. 1, a speaker 900 is fastened to a computer housing 920 by lock bolts 910. During operation of the speaker 900, the vibration is transmitted from the speaker 900 to other electronic modules via the computer housing 920, thereby affecting adversely normal operation of the other electronic modules. For example, if music sounds are produced from the speaker 900 during reading of a hard disk drive, transmission rate of the hard disk can be reduced, or even data transmission of the hard disk may be interrupted.

To solve this problem, soft silicone plugs have been proposed to replace the lock bolts 910 for fastening the speaker 900 to the computer housing 920. Such a change results in an increase in the manufacturing cost of the electronic device.

### SUMMARY OF THE INVENTION

The object of this invention is to provide an electronic device having a speaker unit, which can reduce effectively vibration transmission and which is manufactured at a low cost.

According to an aspect of this invention, an electronic device comprising:

a housing including an upper housing half and a lower housing half connected to and disposed under the upper housing half, the lower housing half being provided with at least one insert post; and

a speaker unit disposed between the upper and lower housing halves of the housing and including
a magnetic element disposed on the upper housing half of the housing, and
a speaker module including a speaker body disposed above and abutting against the lower housing half of the housing and having at least one post-connecting portion, and a magnetic body adapted for generating an audio signal, the post-connecting portion having a hole permitting the insert post to extend movably therethrough, the magnetic element being disposed directly above the magnetic body such that one of a magnetic attractive force and a magnetic repulsive force exists therebetween.

According to another aspect of this invention, there is provided a speaker unit adapted to be fixed in an electronic device, the electronic device including an upper housing half and a lower housing half connected to and disposed under the upper housing half, the lower housing half being provided with at least one insert post, the speaker unit comprising:

a magnetic element adapted to be disposed on the upper housing half; and

a speaker module including a speaker body that is adapted to be disposed above and abut against the lower housing half and that has at least one post-connecting portion, and a magnetic body adapted for generating an audio signal, the post-connecting portion having a hole permitting the insert post to extend movably therethrough, the magnetic element being disposed directly above the magnetic body such that one of a magnetic attractive force and a magnetic repulsive force exists therebetween, so as to diminish or prevent sway of the speaker module along a longitudinal direction of the insert post.

Since the speaker module is not locked or fastened to the lower housing half, and since sway movement of the speaker module is diminished or prevented, vibration transmitted from the speaker module to the upper and lower housing halves can be reduced effectively. Furthermore, due to exclusion of the lock bolts and the soft silicone plugs required for the above-mentioned prior art, the structure of the electronic device is simplified.

### BRIEF DESCRIPTION OF THE DRAWINGS

These and other features and advantages of this invention will become apparent in the following detailed description of two embodiments of this invention, with reference to the accompanying drawings, in which:

FIG. 1 is a fragmentary perspective view of a conventional notebook computer having a speaker;

FIG. 2 is a fragmentary perspective view of the first embodiment of an electronic device according to this invention;

FIG. 3 is a fragmentary exploded side view of the first embodiment;

FIG. 4 is a fragmentary perspective view of the second embodiment of an electronic device according to this invention; and

FIG. 5 is a fragmentary exploded side view of the second embodiment.

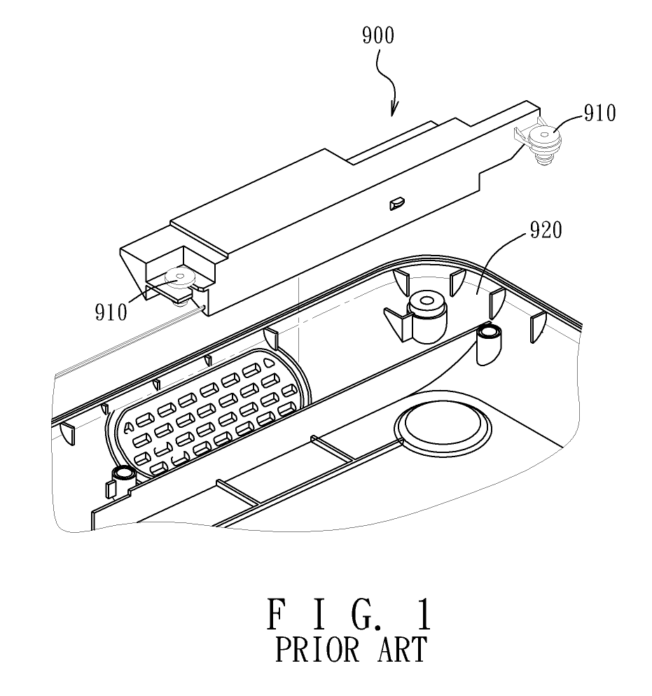

### DETAILED DESCRIPTION OF THE PREFERRED EMBODIMENTS

Before the present invention is described in greater detail in connection with the embodiments, it should be noted that similar elements and structures are designated by like reference numerals throughout the entire disclosure.

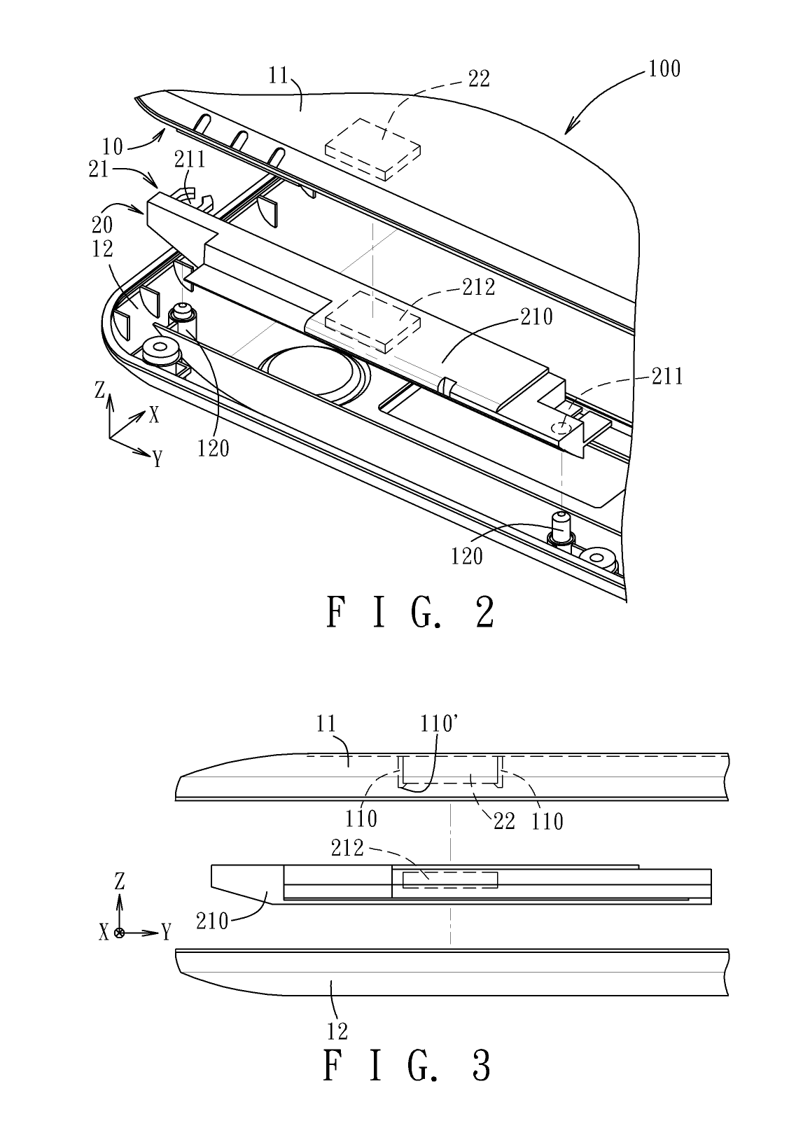

Referring to FIG. 2, the first embodiment of an electronic device 100 according to this invention is a notebook computer. Alternatively, the electronic device may be communication equipment (e.g., smart phone) or a portable electronic product (e.g., MP3 and iPOD). In this embodiment, the electronic device includes a housing 10 and a speaker unit 20.

With further reference to FIG. 3, the housing 10 includes an upper housing half 11 and a lower housing half 12 connected to and disposed under the upper housing half 11. The upper housing half 11 is provided with two parallel clamping plates 110 that extend downwardly therefrom and that have barb-shaped lower ends 110′ extending toward each other. The lower housing half 12 is provided with two insert posts 120 spaced apart from each other.

In this embodiment, the speaker unit 20 is disposed between the upper and lower housing halves 11, 12, and includes a speaker module 21 and a magnetic element 22. The speaker module 21 includes a speaker body 210 having two post-connecting portions each formed with a hole 211 and disposed respectively at two opposite ends of the speaker body 210, and a magnetic body 212. The magnetic body 210 is disposed above and abuts against the lower housing half 12. The holes 211 Of the post-connecting portions permit the insert posts 120 to extend respectively therethrough, so as to prevent movement of the speaker body 210 on the lower housing half 12 along an X-axis direction or a Y-axis direction. The magnetic body 212 is disposed in the speaker body 210 for generating an audio signal. It should be noted that, the diameter of each of the holes 211 is slightly greater than that of the corresponding insert post 120, so as to allow for movement of the speaker module 21 relative to the lower housing half 12 by a limited range. In this manner, the speaker module 21 can be connected to the housing 10 without the lock bolts or the soft silicone plugs required for the above-mentioned prior art. Furthermore, since the speaker module 21 is not locked or fastened to the housing 10, vibration transmitted from the speaker module 21 to the housing 10 is diminished to reduce adverse affection on other electronic elements due to vibration transmission by the housing 10.

The magnetic element 22 is clamped between the clamping plates 110, is disposed between and abuts against the upper housing half 11 and the barb-shaped lower ends 110′ of the clamping plates 110, so as to be fixed to the upper housing half 11. Alternatively, the magnetic element 22 may be fixed to the upper housing half 11 in other manners, for example, by glue or by integral connection.

The magnetic element 22 is disposed directly above the magnetic body 212, such that a magnetic repulsive force exists therebetween, so as to prevent movement of the speaker module 21 away from the lower housing half 12 along the Z-axis direction. The magnetic repulsive force is greater than the weight of the speaker module 21. As such, when the electronic device 100 is moved to an inclined position, an upright position, or an inverted position, contact between the speaker module 21 and the lower housing half 12 can be maintained, so as to prevent sway of the speaker module 21 relative to the housing 10 along a longitudinal direction of the insert posts 120. Consequently, there is no need to provide extra fasteners or retainers for fastening or locking the speaker module 21 to the housing 10, thereby reducing the manufacturing cost of the electronic device 100. Furthermore, since the speaker module 21 is not fastened or locked to the housing 10, vibration transmitted from the speaker module 21 to the housing 10 can be diminished, so that adverse affection of vibration on other electronic elements can be reduced significantly.

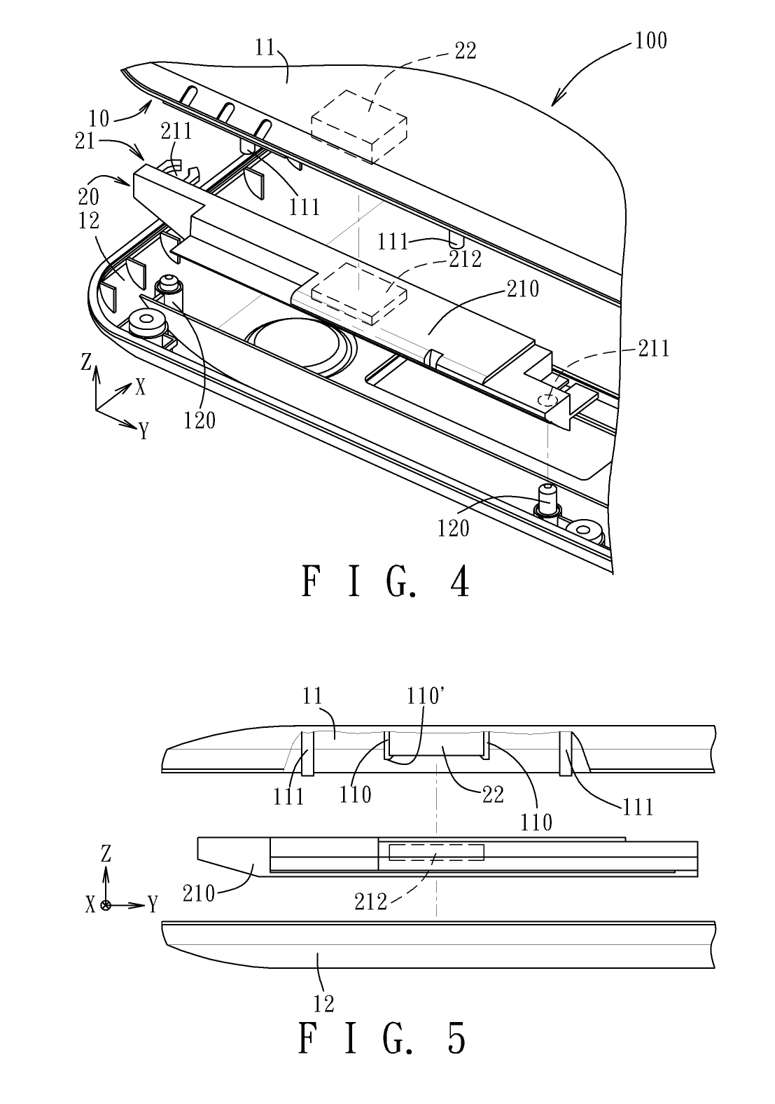

FIGS. 4 and 5 show the second embodiment of an electronic device 100 according to this invention, which differs from the first embodiment in the following. In this embodiment, the upper housing half 11 is further provided with two stop posts 111 that extend downwardly therefrom toward the lower housing half 12 and that are spaced apart from each other. In this embodiment, a magnetic attractive force exists between the magnetic element 22 and the magnetic body 212, and is slightly less than the weight of the speaker module 21. Since the weight of the speaker module 21 is greater than the magnetic attractive force, when the insert rods 120 are vertical, the speaker module 21 is maintained on the lower housing half 12. When the electronic device 100 is moved upside down and the component of the weight of the speaker module 21 along the Z-axis direction is less than the magnetic attractive force, the speaker module 21 comes into contact with the stop posts 111. In this manner, components can be kept in position despite of the attractive force between the magnetic element 22 and the magnetic body 212.

In view of the above, the magnetic element 22 and the magnetic body 212 are used to replace the lock bolts and the soft silicone plugs of the above-mentioned prior art, so as to reduce the manufacturing cost of the electronic device 100. Furthermore, due to the presence of the insert rods 120 and the holes 211, it is not necessary to fasten or lock the speaker module 21 to the housing 10, thereby diminishing transmission of vibration from the speaker module 21 to the housing 10, so as to reduce significantly adverse affection of vibration on other electronic elements. Thus, the object of this invention is achieved.

With this invention thus explained, it is apparent that numerous modifications and variations can be made without departing from the scope and spirit of this invention. It is therefore intended that this invention be limited only as indicated by the appended claims.

I claim:

1. An electronic device comprising:
a housing including an upper housing half and a lower housing half connected to and disposed under said upper housing half, said lower housing half being provided with at least one insert post; and
a speaker unit disposed between said upper and lower housing halves of said housing and including
a magnetic element disposed on said upper housing half of said housing, and
a speaker module including a speaker body disposed above and abutting against said lower housing half of said housing and having at least one post-connecting portion, and a magnetic body adapted for generating an audio signal, said post-connecting portion having a hole permitting said insert post to extend movably therethrough, said magnetic element being disposed directly above said magnetic body such that one of a magnetic attractive force and a magnetic repulsive force exists therebetween.

2. The electronic device as claimed in claim 1, wherein the magnetic repulsive force exists between said magnetic element and said magnetic body, said upper housing half of said housing being provided with two parallel clamping plates that extend downwardly therefrom and that have barb-shaped lower ends extending toward each other, said magnetic element being clamped between said clamping plates and disposed between and abutting against said upper housing half and said barb-shaped lower ends of said clamping plates.

3. The electronic device as claimed in claim 1, wherein the magnetic attractive force exists between said magnetic element and said magnetic body, and is less than the weight of said speaker module, said upper housing half of said housing being provided with a stop post that extends downwardly therefrom toward said speaker module and that is spaced apart from said speaker module at a predetermined vertical distance.

4. A speaker unit adapted to be fixed in an electronic device, the electronic device including an upper housing half and a lower housing half connected to and disposed under the upper housing half, the lower housing half being provided with at least one insert post, said speaker unit comprising:
a magnetic element adapted to be disposed on the upper housing half; and
a speaker module including a speaker body that is adapted to be disposed above and abut against the lower housing half and that has at least one post-connecting portion, and a magnetic body adapted for generating an audio signal, said post-connecting portion having a hole permitting said insert post to extend movably therethrough, said magnetic element being disposed directly above said magnetic body such that one of a magnetic attractive force and a magnetic repulsive force exists therebetween.
